(19) United States
(12) Patent Application Publication
(10) Pub. No.: US 2019/0255893 A1
(43) Pub. Date: Aug. 22, 2019

(54) REAL-TIME ACTIVATION OF TIRE PRESSURE MEASUREMENT SYSTEMS

(71) Applicant: Ford Global Technologies, LLC, Dearborn, MI (US)

(72) Inventors: John Robert Van Wiemeersch, Novi, MI (US); Vivekanandh Elangovan, Canton, MI (US); Ali Hassani, Ann Arbor, MI (US); Dilip B. Patel, Novi, MI (US)

(21) Appl. No.: 15/900,954

(22) Filed: Feb. 21, 2018

(51) Int. Cl. B60C 23/04; G07C 5/00; G07C 5/08; H04W 4/38; H04W 4/44; H04L 12/40

(52) U.S. Cl. CPC B60C 23/0471; B60C 23/0479; G07C 5/008; G07C 5/0816; H04L 2012/40273; H04W 4/44; H04L 12/40013; H04L 12/40039; H04W 4/38

(57) ABSTRACT

Method and apparatus are disclosed for real-time activation of tire pressure measurement systems. An example vehicle includes a communication module and a tire pressure measurement system (TPMS) including a TPMS sensor and a controller. The controller is to determine, responsive to receiving an update request, whether the TPMS sensor is paired with the communication module. The controller also is to, responsive to determining the TPMS sensor is not paired, activate the TPMS in a real-time mode, collect a current measurement from the TPMS sensor upon activation, and present the current measurement.

### TECHNICAL FIELD

The present disclosure generally relates to tire pressure measurement systems and, more specifically, to real-time activation of tire pressure measurement systems.

### BACKGROUND

Typically, vehicles include tires that are coupled to respective wheel rims. Generally, the tires are formed of rubber (e.g., synthetic rubber, natural rubber), fabric, wiring, and/or other materials and chemical compounds that reduce wear-and-tear of the wheels, improve handling, and/or affect other vehicle characteristics (e.g., fuel economy) during operation of a vehicle. Recently, vehicles have implemented tire pressure monitoring systems (TPMSs) that monitor tire pressures and/or other characteristics of the tires. For instance, a vehicle may include a TPMS sensor for each tire of the vehicle.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are shown for real-time activation of tire pressure measurement systems. An example disclosed vehicle includes a communication module and a tire pressure measurement system (TPMS) including a TPMS sensor and a controller. The controller is to determine, responsive to receiving an update request, whether the TPMS sensor is paired with the communication module. The controller also is to, responsive to determining the TPMS sensor is not paired, activate the TPMS in a real-time mode, collect a current measurement from the TPMS sensor upon activation, and present the current measurement.

Some examples further include a cluster unit. In such examples, when a TPMS unit is open in the cluster unit, the controller receives the update request from the cluster unit and presents the current measurement via the cluster unit. In some examples, the controller is configured to activate the TPMS in the real-time mode when a tire corresponding to the tire is stationary. In some examples, the controller receives the update request from a remote server via the communication module. In such examples, the remote server includes at least one of a taxi dispatcher system and an autonomous vehicle administrator portal. In some examples, the controller receives the update request from a mobile device via the communication module when a TPMS app is open on the mobile device. In some such examples, the controller is to send a signal to the mobile device, via the communication module, to instruct the mobile device to present the current measurement.

In some examples, the TPMS is configured to remain in the real-time mode while a TPMS app remains open and return to a previous mode of operation after the TPMS app has been closed for a predetermined period of time. In such examples, the controller instructs the TPMS to decrease a rate at which tire pressure measurements are collected as a time in which the TPMS app remains open increases.

In some examples, the controller presents a previous tire pressure measurement responsive to receiving the update request and prior to collecting the current measurement. In some examples, the controller is configured to present a low-pressure alert responsive to determining that the current measurement is less than a first threshold pressure and present a high-pressure alert responsive to determining that the current measurement is greater than a second threshold pressure.

In some examples, the communication module receives tire pressure measurements from the TPMS sensor via at least one of a Bluetooth® low-energy protocol, an ultra-high frequency protocol, a Wi-Fi® protocol, and an ultra-wide band protocol. In some examples, to activate the TPMS and collect the current measurement from the TPMS sensor, the controller is configured to send a low-frequency wake-up signal to the TPMS sensor via the communication module, establish Bluetooth® low-energy communication between the communication module and the TPMS sensor upon the TPMS sensor receiving the low-frequency wake-up signal, send an instruction to the TPMS sensor via the Bluetooth® low-energy communication to collect the current measurement, and receive the current measurement from the TPMS sensor via the Bluetooth® low-energy communication.

In some examples, the TPMS sensor is not paired with the communication module when the TPMS is in the sleep mode. In such examples, the TPMS enters the sleep mode responsive to a tire being stationary for a predetermined period of time. In some such examples, the TPMS enters an active mode drive mode responsive to the tire rotating after being stationary for the predetermined period of time. In such examples, the TPMS sensor is paired with the communication module when the TPMS is in the active mode.

Some examples further include a gyroscope to detect whether the tire is stationary or rotating. In some examples, the TPMS sensor collects and transmits a tire pressure measurement at a high rate in an active mode, at a low rate in a sleep mode, and at a medium rate in the real-time mode.

An example disclosed method includes receiving an update request for a tire pressure measurement system (TPMS) sensor of a vehicle and determining, upon receiving the update request, whether the TPMS is paired with a communication module of the vehicle. The example disclosed method also includes, responsive to determining that the TPMS sensor is not paired, activating a TPMS in a real-time mode, collecting a current measurement from the TPMS sensor upon activation, and presenting the current measurement via an HMI unit.

In some examples, the update request is received from at least one of a cluster unit and a remote server via the communication module. In some examples, the update request is received from a mobile device via the communication module when a TPMS app is open on the mobile device. Some examples further include presenting a previous tire pressure measurement responsive to receiving the update request and prior to collecting the current measurement.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates an example vehicle in accordance with the teachings herein.

FIG. 2 is a block diagram of electronic components of the vehicle of FIG. 1.

FIG. 3 is a block diagram of electronic components of a mobile device.

FIG. 4 is a flowchart for activating a tire pressure measurement system of a vehicle in accordance with the teachings herein.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

Typically, vehicles include tires that are coupled to respective wheel rims. Generally, the tires are formed of rubber (e.g., synthetic rubber, natural rubber), fabric, wiring, and/or other materials and chemical compounds that reduce wear-and-tear of the wheels, improve handling, and/or affect other vehicle characteristics (e.g., fuel economy) during operation of a vehicle. Recently, vehicles have implemented tire pressure monitoring systems (TPMSs) that monitor tire pressures and/or other characteristics of the tires. For instance, a vehicle may include a TPMS sensor for each tire of the vehicle. In such instances, if one or more of the TPMS sensors detects a low or high tire pressure, a cluster output device of the vehicle is activated to alert an operator (e.g., a driver) of the vehicle to the low or high tire pressure. Oftentimes, TPMS sensors are configured to collect tire pressure measurements once every ten minutes. As a result, a vehicle potentially may be driving along a road for an extended period of time upon being started before the operator is alerted to a low or high tire pressure of a tire.

Example methods and apparatus disclosed herein enable (1) a user to query for real-time tire pressure measurements of tires of a vehicle before, during, and/or after the vehicle is in an on-state and (2) the vehicle to immediately present the real-time tire pressure measurements and/or low-pressure warning(s) to the user via an output device of the vehicle and/or a mobile device of the user. Examples disclosed herein include a vehicle including a TPMS that monitors tire pressures of tires of the vehicle. Each tire of the vehicle includes a TPMS sensor that wirelessly communicates a tire pressure measurement to a TPMS controller via Bluetooth® low-frequency (BLE), ultra-high frequency (UHF), Wi-Fi®, and/or other wireless communication protocol(s). The TPMS enters a real-time query state (RTQS) upon receiving a request to do so. For example, the TPMS controller receives the request from a mobile device of a user, a cluster input device of the vehicle, and/or a remote server (e.g., taxi dispatcher, an autonomous vehicle operations portal). Upon receiving the request, the TPMS controller checks to see if a communication module of the vehicle is currently paired with each of the TPMS sensors of the vehicle. If not, the communication module sends a low-frequency wake-up signal to set the TPMS in the RTQS. In some examples, the low-frequency wake-up signal is encoded with an instruction to activate into the RTQS. Further, in some examples, the communication module sends the low-frequency wake-up signal to initiate pairing to the TPMS sensors. In the RTQS (also referred to as a real-time mode), the TPMS sensors broadcast tire pressure data at an increased rate relative to that of a sleep state of the TPMS and a reduced rate relative to that of an active state of the TPMS. The TPMS relays the real-time data to the user and/or presents an alert to the user if the pressure data is outside of an acceptable range. The TPMS remains in the RTQS for a predetermined period of time after (1) the query request is received and/or (2) a TPMS app remains active on the mobile device of the user.

As used herein, a “key fob” refers to a dedicated electronic mobile device that wirelessly communicates with a vehicle to unlock and/or lock one or more vehicle doors, open and/or close one or more of the vehicle doors, activate an engine of the vehicle, and/or control other function(s) of the vehicle. In some examples, a user of a vehicle utilizes a mobile device that functions as a phone-as-a-key for wireless communication with the vehicle. As used herein, a “phone-as-a-key” refers to an electronic mobile device (e.g., a smart phone, a wearable, a smart watch, a tablet, etc.) that includes hardware and/or software to function as a key fob.

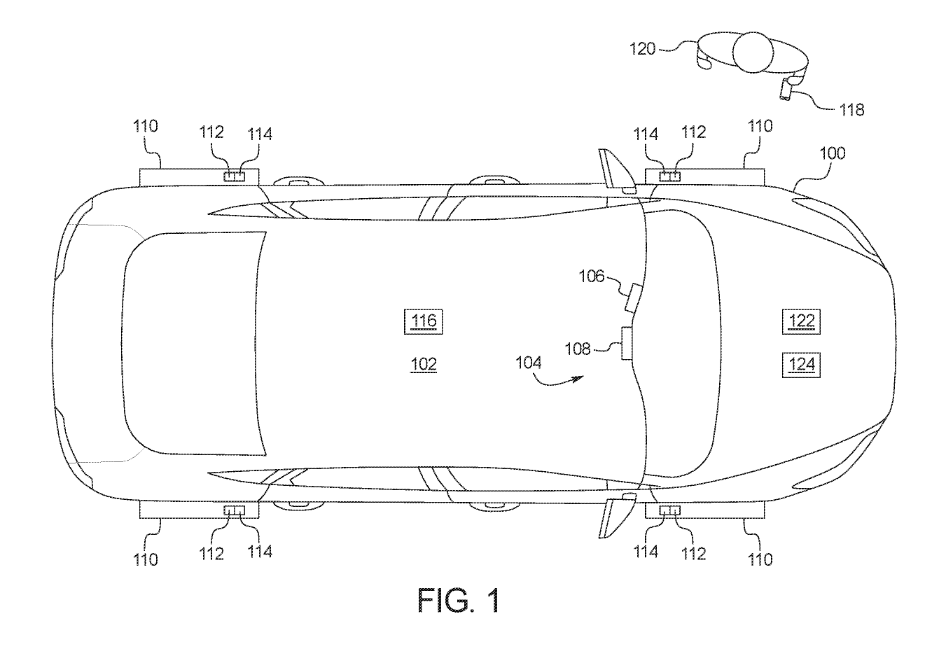

Turning to the figures, FIG. 1 illustrates an example vehicle 100 in accordance with the teachings herein. The vehicle 100 may be a standard gasoline powered vehicle, a hybrid vehicle, an electric vehicle, a fuel cell vehicle, and/or any other mobility implement type of vehicle. The vehicle 100 includes parts related to mobility, such as a powertrain with an engine, a transmission, a suspension, a driveshaft, and/or wheels, etc. The vehicle 100 may be non-autonomous, semi-autonomous (e.g., some routine motive functions controlled by the vehicle 100), or autonomous (e.g., motive functions are controlled by the vehicle 100 without direct driver input).

In the illustrated example, the vehicle 100 includes a cabin 102 and an HMI unit 104 located within the cabin 102. The HMI unit 104 provides an interface between the vehicle 100 and a user. The HMI unit 104 includes digital and/or analog interfaces (e.g., input devices and output devices) to receive input from and display information for the user(s). The input devices include, for example, a control knob, an instrument panel, a digital camera for image capture and/or visual command recognition, a touchscreen, an audio input device (e.g., cabin microphone), buttons, a touchpad, and/or other input devices of a cluster unit 106. The output devices may include instrument cluster outputs (e.g., dials, lighting devices) of the cluster unit 106, actuators, a display 108 (e.g., a heads-up display, a center console display such as a liquid crystal display (LCD), an organic light emitting diode (OLED) display, a flat panel display, a solid state display, etc.), and/or speakers. In some examples, the display 108 is a touchscreen that is configured to function as an input device and an output device. In the illustrated example, the HMI unit 104 includes hardware (e.g., a processor or controller, memory, storage, etc.) and software (e.g., an operating system, etc.) for an infotainment system (such as SYNC® and MyFord Touch® by Ford®). Additionally, the HMI unit 104 displays the infotainment system on, for example, the display 108.

The vehicle 100 of the illustrated example also includes tires 110. For example, the tires 110 are coupled to respective wheel rims of the vehicle 100. In some examples, the tires 110 are formed of rubber (e.g., synthetic rubber, natural rubber), fabric, wiring, and/or other materials and chemical compounds that reduce wear-and-tear of the wheels, improve handling, and/or affect other vehicle characteristics (e.g., fuel economy) during operation of the vehicle 100. Further, in some examples, the tires 110 include treads (i.e., grooved patterns) on their outer surfaces to further improve handling during operation of the vehicle 100.

Further, the vehicle 100 of the illustrated example includes tire pressure management system (TPMS) sensors 112, gyroscopes 114, and a communication module 116. For example, each of the tires 110 includes one of the TPMS sensors 112 and one of the gyroscopes 114.

The TPMS sensors 112 of the illustrated example include circuitry configured to determine tire pressures and/or other characteristics of the tires 110. For example, each of the TPMS sensors 112 include one or more processors and/or memory that may enable the TPMS sensors 112 to carry out one or more functions. Each of the TPMS sensors 112 includes a pressure sensor to detect a tire pressure of the corresponding one of the tires 110. Further, each of the TPMS sensors 112 includes circuitry to facilitate communication with one or more devices or systems, such as the communication module 116 of vehicle 100. For example, each of the TPMS sensors 112 include antenna(s) that are configured to (i) receive and transmit data collected from a pressure sensor and/or other sensor(s) of the TPMS sensors 112 and (ii) send and receive signals (e.g., activation signals, wake-up signals, pairing signals, instructions, etc.) from the communication module 116 of the vehicle 100. The antenna(s) and/or communication module of each of the TPMS sensors 112 enable communication with the communication module 116 of the vehicle 100 via low-frequency signals, high-frequency signals, ultra-high frequency (e.g., 315 MHz and/or 433 MHz) signals, Ultra-Wide Band (UWB) signals, Bluetooth® communication protocol, Bluetooth® Low Energy (BLE) protocol, Wi-Fi communication protocol (e.g., IEEE 802.11 a/b/g/n/ac), etc.

Further, each of the gyroscopes 114 of the illustrated example detects rotation of the corresponding one of the tires 110. That is, each of the gyroscopes 114 detects whether the corresponding one of the tires 110 is stationary or rotating. For example, each of the gyroscopes 114 is communicatively coupled to a corresponding one of the TPMS sensors 112 to enable the TPMS sensors 112 to establish wireless communication with the communication module 116 of the vehicle 100. In some examples, each of the TPMS sensors 112 are configured to include one of the gyroscopes 114 to enable the gyroscopes 114 to wirelessly communicate with the communication module 116. Additionally or alternatively, the vehicle 100 and/or the TPMS sensors 112 includes other sensors (e.g., accelerometers) that are configured to monitor rotation of the tires 110.

The communication module 116 of the illustrated example is configured to communicatively connect to a mobile device 118 (e.g., a key fob and/or a phone-as-a-key) of a user 120 of the vehicle 100. The communication module 116 includes hardware and firmware to establish a wireless connection with the mobile device 118. For example, the communication module 116 includes a wireless personal area network (WPAN) module that wirelessly communicates with mobile device(s) of user(s) (e.g., the mobile device 118 of the user 120) via short-range wireless communication protocol(s). In some examples, the communication module 116 implements the Bluetooth® and/or BLE protocols. The Bluetooth® and BLE protocols are set forth in Volume 6 of the Bluetooth® Specification 4.0 (and subsequent revisions) maintained by the Bluetooth® Special Interest Group. Additionally or alternatively, the communication module 116 is configured to wirelessly communicate via ultra-high frequency, Wi-Fi®, Near Field Communication (NFC), UWB (Ultra-Wide Band), and/or any other short-range and/or local wireless communication protocol (e.g., IEEE 802.11 a/b/g/n/ac) that enables the communication module 116 to communicatively couple to the mobile device 118 of the user 120.

Further, the vehicle 100 includes a communication module 122 that includes wired or wireless network interfaces to enable communication with external networks. The communication module 122 also includes hardware (e.g., processors, memory, storage, antenna, etc.) and software to control the wired or wireless network interfaces. In the illustrated example, the communication module 122 includes one or more communication controllers for cellular networks (e.g., Global System for Mobile Communications (GSM), Universal Mobile Telecommunications System (UMTS), Long Term Evolution (LTE), Code Division Multiple Access (CDMA)), Near Field Communication (NFC) and/or other standards-based networks (e.g., WiMAX (IEEE 802.16m); local area wireless network (including IEEE 802.11 a/b/g/n/ac or others), Wireless Gigabit (IEEE 802.11ad), etc.). In some examples, the communication module 122 includes a wired or wireless interface (e.g., an auxiliary port, a Universal Serial Bus (USB) port, a Bluetooth® wireless node, etc.) to communicatively couple with a mobile device (e.g., a smart phone, a wearable, a smart watch, a tablet, etc.). In such examples, the vehicle 100 may communicate with the external network via the coupled mobile device. The external network(s) may be a public network, such as the Internet; a private network, such as an intranet; or combinations thereof, and may utilize a variety of networking protocols now available or later developed including, but not limited to, TCP/IP-based networking protocols.

The vehicle 100 of the illustrated examples also includes a TPMS controller 124. For example, the TPMS controller 124 is configured to activate, localize, and collect measurements from TPMS sensors 112 of the tires 110 and present low-energy alert(s) based on the collected tire pressure measurements. That is, the TPMS controller 124 is configured to collect currently tire pressure measurements from the TPMS sensors 112 via wireless communication and present those tire pressure measurements to the user 120. Further, the TPMS controller 124 is configured to compare the collected tire pressure measurements to tire pressure thresholds and present alert(s) (e.g., a low-pressure alert, a high-pressure alert) to the user 120 based on the comparisons. For example, the TPMS controller 124 presents a low-pressure alert when one or more of the tire pressure measurements is less than a first tire pressure threshold (e.g., a low pressure threshold) and presents a high-pressure alert when one or more of the tire pressure measurements is greater than a second tire pressure threshold (e.g., a high pressure threshold). In some examples, the tire pressure thresholds correspond to a factory-recommended lower limit and/or a factory-recommended upper limit of a tire pressure for the tires 110 and/or the vehicle 100.

In the illustrated example, the TPMS and the TPMS sensors 112 of the TPMS are configured to be in sleep mode (also referred to as a stationary mode), active mode (also referred to as a driving mode), and/or real-time mode (also referred to as a real-time query state). The TPMS controller 124 monitors characteristics of the vehicle 100 and monitors for instructions from the user 120 to determine in which mode to set the TPMS of the vehicle 100.

The TPMS enters sleep mode upon determining that the vehicle 100 has been stationary for a predetermined period of time (e.g., 5 minutes, 10 minutes, etc.). For example, the vehicle 100 may be stationary for the predetermined period of time when the vehicle 100 is parked and/or when the vehicle 100 is stuck in traffic. In the illustrated example, the TPMS controller 124 is configured to collect measurements from the gyroscopes 114 and/or other sensors (e.g., accelerometers) coupled to the tires 110 to determine whether the tires 110 are stationary or rotating. That is, the gyroscopes 114 and/or other sensors detect rotation of the tires 110 to enable the TPMS controller 124 to identify whether the tires 110 are stationary or rotating. If the TPMS controller 124 determines that the vehicle 100 is stationary for the predetermined period of time, the TPMS of the vehicle 100 is set in the sleep mode. When the TPMS is set in the sleep mode, the TPMS sensors 112 are not paired with the communication module 116 of the vehicle 100. Further, when the TPMS is in the sleep mode, the TPMS sensors 112 are configured to collect tire pressure measurements at a low rate with extended intervals (e.g., once each 6 hours) to reduce the amount of energy consumed by the TPMS sensors 112 over a period of time while the vehicle 100 is not moving.

Further, the TPMS of the vehicle 100 is set in the active mode upon the TPMS controller 124 determining that the vehicle 100 is moving (e.g., after being stationary for a predetermined period of time). For example, the TPMS controller 124 detects that the vehicle 100 is moving when the gyroscopes 114 and/or other sensors detect that the tires 110 are rotating. Further, in some examples, the TPMS of the vehicle 100 enters the active mode in response to the TPMS controller 124 determining that the user 120 is about to operate the vehicle 100. That is, in such examples, the TPMS is configured to enter the active mode upon the TPMS controller 124 identifying an anticipated driving state of the vehicle 100.

Upon transitioning to the active mode, the TPMS sensors 112 are activated for monitoring the tires 110. To activate the TPMS sensors 112 in the active mode, communication is established between the TPMS sensors 112 and the communication module 116 of the vehicle 100 by pairing the TPMS sensors 112 to the communication module 116 and/or other communication module(s) of the vehicle 100. For example, the TPMS controller 124 pairs the TPMS sensors 112 to the communication module 116 via BLE, Bluetooth®, Wi-Fi®, UWB, and/or any other communication protocol. Upon pairing the TPMS sensors 112, the TPMS controller 124 sends an instruction, via the communication module 116, to the TPMS sensors 112 to instruct the TPMS sensors 112 to collect tire pressure measurements from the tires 110.

Further, the TPMS controller 124 localizes the tires 110 based on the communication between the TPMS sensors 112 and the communication module 116. That is, the TPMS controller 124 identifies the location of each of the TPMS sensors 112 and the corresponding tires 110 based on the communication between the TPMS sensors 112 and the communication module 116. For example, the TPMS controller 124 identifies which of the TPMS sensors 112 is located at a front driver-side wheel well, a front passenger-side wheel well, a rear driver-side wheel well, and a rear passenger-side wheel well. In some examples, the TPMS controller 124 is configured to determine locations of the TPMS sensors 112 based upon received signal strength indicators (RSSIs), time-of-flight, and/or angle-of-arrival of signals sent between the TPMS sensors 112 and the communication module 116 and/or other communication module(s) located throughout the vehicle 100. For example, the TPMS controller 124 may utilize triangulation and/or trilateration to localize the TPMS sensors 112 based upon the RSSIs, time-of-flight, and/or angle-of-arrival of signals sent between the TPMS sensors 112 and a plurality of communication modules of the vehicle 100.

When the TPMS sensors 112 are in the active mode, the TPMS sensors 112 collect tire pressure measurements at a high rate with short intervals (e.g., once every minute) to enable the TPMS sensors 112 to quickly detect a drop in air pressure of the tires 110 while the vehicle 100 is moving. For example, by collecting tire pressure measurements at short intervals, the TPMS sensors 112 are able to detect a puncture to one of the tires 110 while the vehicle 100 is traveling along a road. Upon collecting the tire pressure measurements, the TPMS sensors 112 send the tire pressure measurements to the TPMS controller 124 via the communication module 116 of the vehicle 100. For example, the communication module 116 communicates with the TPMS sensors 112 via ultra-high frequency (UHF) communication, BLE communication, Bluetooth® communication, Wi-Fi® Communication, UWB communication, and/or any other communication protocol to collect the tire pressure measurements from the TPMS sensors 112. Further, the TPMS controller 124 compares the tire pressure measurements to tire pressure threshold(s) of the tires 110 and/or the vehicle 100. The TPMS controller 124 presents a low-pressure alert to the user 120 (e.g., via the cluster unit 106, the display 108, the mobile device 118, etc.) if one or more of the tire pressure measurements is less than a low pressure threshold and presents a high-pressure alert to the user 120 if one or more of the tire pressure measurements is greater than a high pressure threshold.

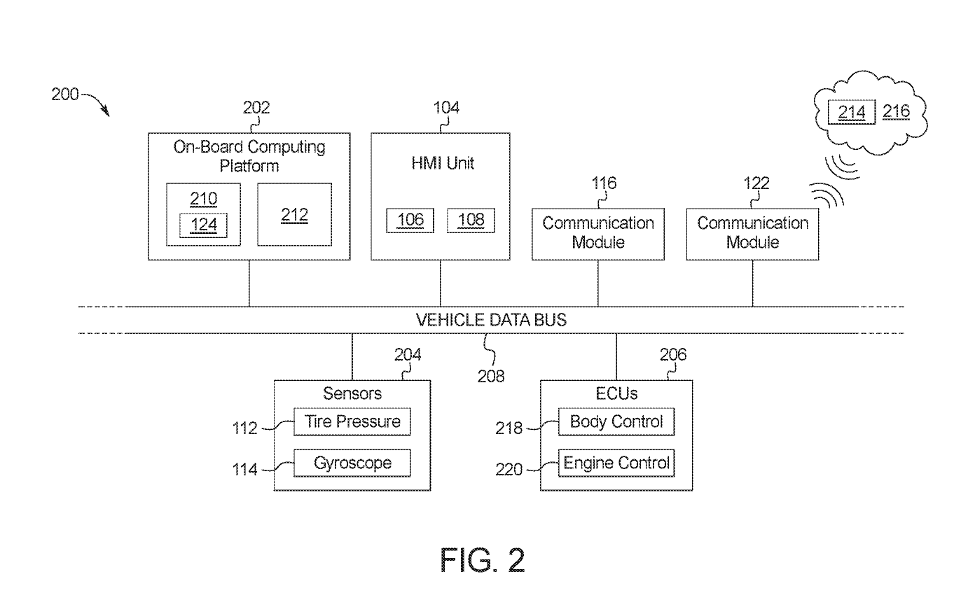

In the illustrated example, the TPMS of the vehicle 100 is set in a real-time mode (also referred to as a real-time query state or RTQS) upon receiving a tire pressure update request from the user 120. For example, the TPMS controller 124 sets the TPMS in the real-time mode in response to receiving an update request from (1) the HMI unit 104, (2) a remote server (e.g., a remote server 214 of FIG. 2) via the communication module 122 of the vehicle 100, and/or (3) the mobile device 118 (e.g., when a TPMS app is open on the mobile device 118) via the communication module 116 of the vehicle 100. The TPMS controller 124 is configured to receive the request and set the TPMS in the real-time mode when the vehicle 100 is moving and/or stationary and when the tires 110 are rotating and/or stationary.

In the illustrated example, to activate the TPMS sensors 112 into the real-time mode and/or the active mode from the sleep mode, the TPMS controller 124 sends a low-frequency wake-up signal to the TPMS sensors 112 via the communication module 116. For example, the TPMS controller 124 sends the low-frequency wake-up signal to activate the TPMS sensors 112 into the active mode in response to one or more of the gyroscopes 114 and/or other sensors detecting that one or more of the tires 110 has started to rotate. Further, the TPMS controller 124 sends the low-frequency wake-up signal to activate the TPMS sensors 112 into the real-time mode in response to the TPMS controller 124 receiving a tire pressure update request from the user 120 and/or another entity (e.g., a taxi dispatcher, an autonomous vehicle administrator, etc.). Additionally or alternatively, the TPMS controller 124 may be configured to not activate the TPMS sensors 112 into the real-time mode upon determining that the vehicle 100 has entered a geographical region and/or jurisdiction in which transmission of such data is not permitted.

Subsequently, the TPMS controller 124 establishes communication between the TPMS sensors 112 and the communication module 116 upon the TPMS sensors 112 receiving the low-frequency wake-up signal. In some examples, communication is established between the TPMS sensors 112 and the communication module 116 of the vehicle 100 upon pairing the TPMS sensors 112 to the communication module 116 and/or other communication module(s) of the vehicle 100. The TPMS controller 124 pairs the TPMS sensors 112 to establish BLE communication, Bluetooth® communication, Wi-Fi® communication, UWB communication, and/or any other form of communication between the TPMS sensors 112 and the communication module 116. Upon pairing the TPMS sensors 112 for communication with the communication module 116, the TPMS controller 124 sends an instruction, via the communication module 116 (e.g., via ultra-high frequency, BLE, Bluetooth®, Wi-Fi®, UWB, etc.), to the TPMS sensors 112 to instruct the TPMS sensors 112 to collect tire pressure measurements from the tires 110. Further, upon collecting the tire pressure measurements, the TPMS sensors 112 send the tire pressure measurements to the TPMS controller 124 via the communication module 116 of the vehicle 100. That is, the TPMS controller 124 collects the tire pressure measurements from the TPMS sensors 112 via the communication module 116. For example, the communication module 116 receives the tire pressure measurements from the TPMS sensors 112 via ultra-high frequency communication, BLE communication, Bluetooth® communication, Wi-Fi® Communication, UWB communication, and/or any other communication protocol to collect the tire pressure measurements from the TPMS sensors 112.

In the illustrated example, the TPMS controller 124 is configured to determine whether the TPMS sensors 112 are paired with the communication module 116 and/or other communication module(s) of the vehicle 100 upon receiving an update request. For example, responsive to receiving an update request, the TPMS controller 124 determines whether the TPMS sensors 112 are paired with the communication module 116. In such examples, if the TPMS sensors 112 are not paired as a result of the TPMS being in the sleep mode, the TPMS controller 124 activates the TPMS into the real-time mode and pairs the TPMS sensors 112 to establish wireless communication. Further, if the TPMS sensors 112 are paired as a result of the TPMS being in the real-time mode and/or the active mode, the TPMS controller 124 is configured to maintain the pairings of the TPMS sensors 112. For example, if the TPMS is in the active mode when an update request is received, the TPMS remains in the active mode. Further, if the TPMS is in the real-time mode when an update request is received, the TPMS remains in the real-time mode.

Upon activating the TPMS into the real-time mode and/or receiving an update request while the TPMS is into the real-time mode, the TPMS controller 124 presents the most recently previously collected tire pressure measurements to the user 120 (e.g., via the HMI unit 104, the mobile device 118, etc.). Further, the TPMS controller 124 collects current tire pressure measurements from the TPMS sensors 112 at a real-time mode rate. For example, in the real-time mode rate the TPMS sensors 112 are configured to collect tire pressure measurements at a medium rate (e.g., one sample between every five to ten minutes). In some examples, the real-time mode rate varies. For example, the real-time mode rate at which tire pressure measurements are collected decrease over time as a TPMS app remains open on the mobile device 118. In such examples, the TPMS of the vehicle 100 remains in the real-time mode while the TPMS app remains open and transitions to whichever mode the TPMS would otherwise be in if not for the real-time mode after the TPMS app has been closed for a predetermined period of time (e.g., 5 minutes, 10 minutes, etc.). For example, the TPMS is configured to return to the sleep mode and/or the active mode after the TPMS app has been closed for the predetermined period of time.

Further, in some examples one-way beacon communication (e.g., via ultra-high frequency, BLE, Bluetooth®, Wi-Fi®, UWB, etc.) is utilized for the TPMS. In such examples, a low-frequency wake-up beacon is encoded with a real-time mode message that instructs the TPMS sensors 112 to establish communication with the communication module 116. The TPMS controller 124 sends the real-time mode message to the TPMS sensors 112 upon receiving a tire pressure update request. In turn, the TPMS sensors 112 send an acknowledgement signal to the communication module 116 to establish the real-time mode of the TPMS. Subsequently, the TPMS sensors 112 collect tire pressure measurements from the tires 110 in the real-time mode. In some such examples, the TPMS controller 124 is configured to send the real-time mode message via the low-frequency beacons at regular intervals (e.g., 1 beacon per minute). In such examples, the TPMS sensors 112 are configured to remain in the real-time mode for a predefined time duration (e.g., 1 minute) and/or until a stop message is received within a low-frequency beacon. For example, the TPMS controller 124 stops sending the real-time mode messages via the low-frequency beacons upon identifying that the TPMS is to exit from the real-time mode. When the TPMS sensors 112 stop receiving the real-time mode messages via the low-frequency beacons, the TPMS transitions to whichever mode the TPMS would otherwise be in if not for the real-time mode (e.g., sleep mode, active mode). Further, in some examples, the TPMS is configured to return to the sleep mode and/or the active mode after the TPMS app has been closed for the predetermined period of time.

Upon collecting the current tire pressure measurements from the TPMS sensors 112, the TPMS controller 124 presents the current tire pressure measurements to the user 120. For example, the TPMS controller 124 presents the current tire pressure measurements via the HMI unit 104 and/or sends a signal to the mobile device 118, via the communication module 116, to instruct the mobile device 118 to present the current tire pressure measurements.

The TPMS controller 124 of the illustrated example also is configured to compare the tire pressure measurements to tire pressure thresholds. Further, the TPMS controller 124 is configured to present a pressure alert to the user 120 (e.g., via the HMI unit 104, the mobile device 118, etc.) in response to determining that one or more of the tire pressure measurements is less than a first tire pressure threshold and/or greater than a second tire pressure threshold. For example, the TPMS controller 124 presents a low-pressure alert upon identifying a low tire pressure for one of the tires 110 and/or a high-pressure alert upon identifying a high tire pressure for one of the tires 110.

In some examples, the TPMS controller 124 stores (e.g., via memory 212 of FIG. 2) the tire pressure measurement(s) and/or alert(s) for presentation at a later time. For example, the TPMS controller 124 is configured to present the tire pressure measurement(s), low-pressure alert(s), and/or high-pressure alert(s) via the HMI unit 104 upon detecting that the user 120 is within the cabin of the vehicle 100. Additionally or alternatively, the TPMS controller 124 is configured to sends a signal to the mobile device 118 of the user 120, via the communication module 116, to present low-pressure and/or high-pressure alert(s) to the user 120 via the mobile device 118. For example, the TPMS controller 124 instructs the mobile device 118 to present the alerts to the user 120 to enable the user 120 to identify whether one or more of the tires 110 has low pressure or and/or high pressure before starting the vehicle 100.

FIG. 2 is a block diagram of electronic components 200 of the vehicle 100. As illustrated in FIG. 2, the electronic components 200 include an on-board computing platform 202, the HMI unit 104, the communication module 116, the communication module 122, sensors 204, electronic control units (ECUs) 206, and a vehicle data bus 208.

The on-board computing platform 202 includes a microcontroller unit, controller or processor 210 and memory 212. In some examples, the processor 210 of the on-board computing platform 202 is structured to include the TPMS controller 124. Alternatively, in some examples, the TPMS controller 124 is incorporated into another electronic control unit (ECU) with its own processor 210 and memory 212. The processor 210 may be any suitable processing device or set of processing devices such as, but not limited to, a microprocessor, a microcontroller-based platform, an integrated circuit, one or more field programmable gate arrays (FPGAs), and/or one or more application-specific integrated circuits (ASICs). The memory 212 may be volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc). In some examples, the memory 212 includes multiple kinds of memory, particularly volatile memory and non-volatile memory.

The memory 212 is computer readable media on which one or more sets of instructions, such as the software for operating the methods of the present disclosure, can be embedded. The instructions may embody one or more of the methods or logic as described herein. For example, the instructions reside completely, or at least partially, within any one or more of the memory 212, the computer readable medium, and/or within the processor 210 during execution of the instructions.

The terms “non-transitory computer-readable medium” and “computer-readable medium” include a single medium or multiple media, such as a centralized or distributed database, and/or associated caches and servers that store one or more sets of instructions. Further, the terms “non-transitory computer-readable medium” and “computer-readable medium” include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

In the illustrated example, the HMI unit 104 includes the cluster unit 106 and the display 108. Further, the communication module 116 is configured to wirelessly communicate with the mobile device 118 of the user 120, for example, to receive a tire-pressure update request from the mobile device 118 and/or to present a tire pressure measurement to the user 120 via the mobile device 118. The communication module 122 is configured to wirelessly communicate with a remote server 214 of a network 216, for example, to receive a tire-pressure update request from the remote server 214. In some examples, the remote server 214 includes a taxi dispatcher system to enable a taxi dispatcher to initiate tire pressure measurements for the vehicle 100 and/or an autonomous vehicle administrator portal to enable an autonomous vehicle administrator to initiate tire pressure measurements for the vehicle 100.

The sensors 204 are arranged in and around the vehicle 100 to monitor properties of the vehicle 100 and/or an environment in which the vehicle 100 is located. One or more of the sensors 204 may be mounted to measure properties around an exterior of the vehicle 100. Additionally or alternatively, one or more of the sensors 204 may be mounted inside a cabin of the vehicle 100 or in a body of the vehicle 100 (e.g., an engine compartment, wheel wells, etc.) to measure properties in an interior of the vehicle 100. For example, the sensors 204 include accelerometers, odometers, tachometers, pitch and yaw sensors, wheel speed sensors, microphones, tire pressure sensors, biometric sensors and/or sensors of any other suitable type. In the illustrated example, the sensors 204 include the TPMS sensors 112 that collect tire pressure measurements of the tires 110 and the gyroscopes 114 and/or other sensors that detect rotation of the tires 110.

The ECUs 206 monitor and control the subsystems of the vehicle 100. For example, the ECUs 206 are discrete sets of electronics that include their own circuit(s) (e.g., integrated circuits, microprocessors, memory, storage, etc.) and firmware, sensors, actuators, and/or mounting hardware. The ECUs 206 communicate and exchange information via a vehicle data bus (e.g., the vehicle data bus 208). Additionally, the ECUs 206 may communicate properties (e.g., status of the ECUs 206, sensor readings, control state, error and diagnostic codes, etc.) to and/or receive requests from each other. For example, the vehicle 100 may have dozens of the ECUs 206 that are positioned in various locations around the vehicle 100 and are communicatively coupled by the vehicle data bus 208.

In the illustrated example, the ECUs 206 include a body control module 218 and an engine control unit 220. For example, the body control module 218 controls one or more subsystems throughout the vehicle 100, such as power windows, power locks, an immobilizer system, power mirrors, etc. For example, the body control module 218 includes circuits that drive one or more of relays (e.g., to control wiper fluid, etc.), brushed direct current (DC) motors (e.g., to control power seats, power locks, power windows, wipers, etc.), stepper motors, LEDs, etc. Further, the engine control unit 220 control(s) operation (e.g., ignition) of an engine of the vehicle 100.

The vehicle data bus 208 communicatively couples the HMI unit 104, the communication module 116, the communication module 122, the on-board computing platform 202, the sensors 204, and the ECUs 206. In some examples, the vehicle data bus 208 includes one or more data buses. The vehicle data bus 208 may be implemented in accordance with a controller area network (CAN) bus protocol as defined by International Standards Organization (ISO) 11898-1, a Media Oriented Systems Transport (MOST) bus protocol, a CAN flexible data (CAN-FD) bus protocol (ISO 11898-7) and/a K-line bus protocol (ISO 9141 and ISO 14230-1), and/or an Ethernet™ bus protocol IEEE 802.3 (2002 onwards), etc.

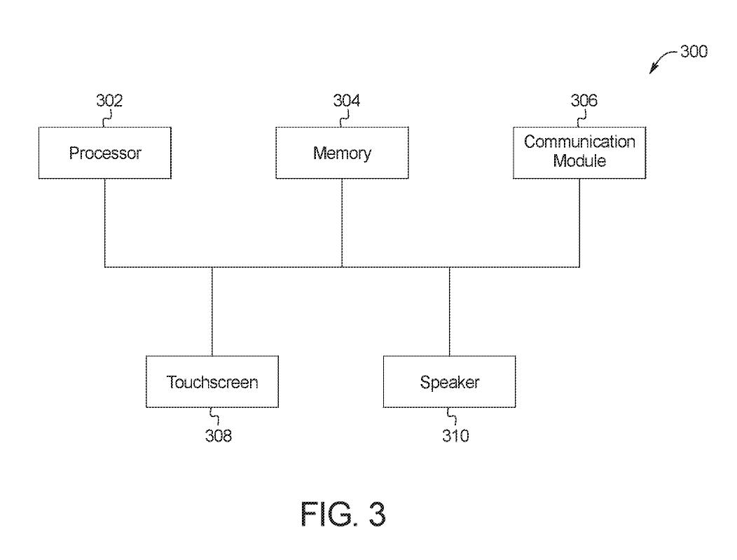

FIG. 3 is a block diagram of electronic components 300 of the mobile device 118. As illustrated in FIG. 3, the electronic components 300 include a processor 302, memory 304, a communication module 306, a touchscreen 308, and a speaker 310.

The processor 302 of the illustrated example may be any suitable processing device or set of processing devices such as, but not limited to, a microprocessor, a microcontroller-based platform, an integrated circuit, one or more field programmable gate arrays (FPGAs), and/or one or more application-specific integrated circuits (ASICs). The memory 304 may be volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc). In some examples, the memory 304 includes multiple kinds of memory, particularly volatile memory and non-volatile memory. Further, the memory 304 is computer readable media on which one or more sets of instructions, such as the software for operating the methods of the present disclosure, can be embedded. The instructions may embody one or more of the methods or logic as described herein. For example, the instructions reside completely, or at least partially, within any one or more of the memory 304, the computer readable medium, and/or within the processor 302 during execution of the instructions.

The communication module 306 includes wired or wireless network interfaces to enable communication with other devices and/or external networks. The external network(s) may be a public network, such as the Internet; a private network, such as an intranet; or combinations thereof, and may utilize a variety of networking protocols now available or later developed including, but not limited to, TCP/IP-based networking protocols. The communication module 306 also includes hardware (e.g., processors, memory, storage, antenna, etc.) and software to control the wired or wireless network interfaces. For example, the communication module 306 includes one or more communication controllers for cellular networks, such as Global System for Mobile Communications (GSM), Universal Mobile Telecommunications System (UMTS), Long Term Evolution (LTE), Code Division Multiple Access (CDMA). In the illustrated example, the communication module 306 includes a wireless personal area network (WPAN) module that is configured to wirelessly communicate with the communication module 116 of the vehicle 100 via short-range wireless communication protocol(s). In some examples, the communication module 306 implements the Bluetooth® and/or Bluetooth® Low Energy (BLE) protocols. The Bluetooth® and BLE protocols are set forth in Volume 6 of the Bluetooth® Specification 4.0 (and subsequent revisions) maintained by the Bluetooth® Special Interest Group. Additionally or alternatively, the communication module 306 is configured to wirelessly communicate via Wi-Fi®, Near Field Communication (NFC), UWB (Ultra-Wide Band), and/or any other short-range and/or local wireless communication protocol (e.g., IEEE 802.11 a/b/g/n/ac) that enables the communication module 306 to communicatively couple to the communication module 116 of the vehicle 100.

The touchscreen 308 of the illustrated example provides an interface between the user 120 and the mobile device 118 to enable the user 120 to remotely send a tire-pressure update request via the mobile device 118. The touchscreen 308 is a resistive touchscreen, a capacitive touchscreen, and/or any other type of touchscreen that displays output information to and tactilely receives input information from the user 120 of the mobile device 118. In some examples, the electronic components 300 of the mobile device 118 also includes other input devices (e.g., buttons, knobs, microphones, etc.) to receive input information from the user 120. Additionally or alternatively, the electronic components 300 of the mobile device 118 includes other output devices, such as the speaker 310, LEDs, etc., to provide output information (e.g., audibly, visually, tactilely) to the user 120 of the mobile device 118. For example, the user 120 interacts with the touchscreen 308 to request a tire pressure update. The communication module 306 of the mobile device 118 wirelessly communicates with the communication module 116 of the vehicle 100 to initiate collection and/or presentation of the tire pressure measurements.

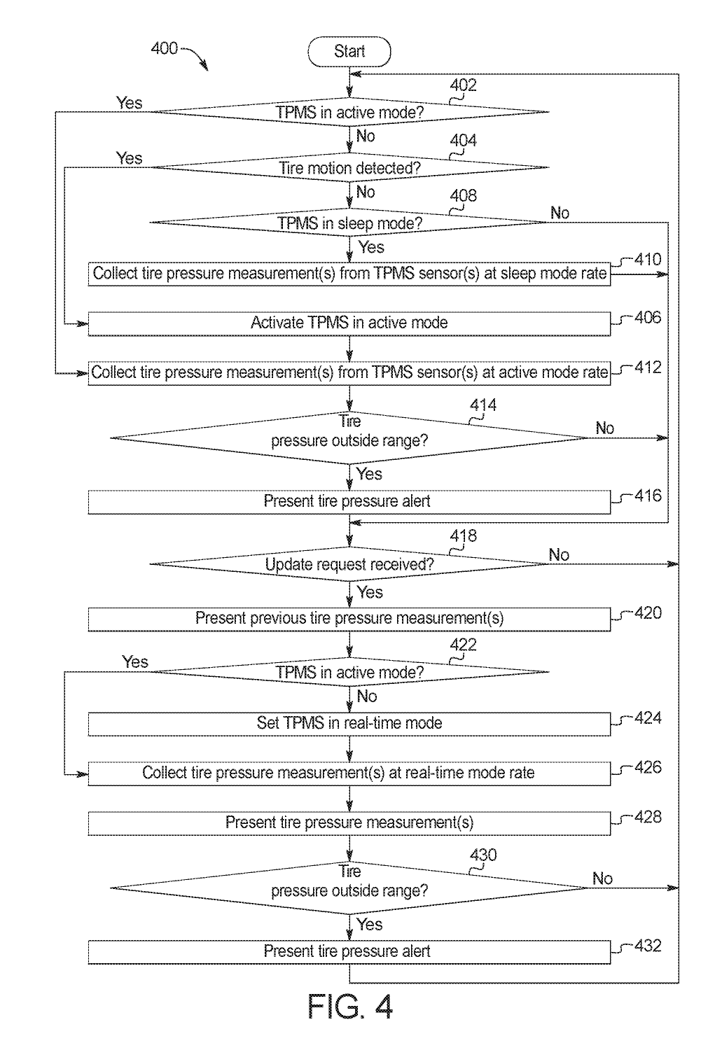

FIG. 4 is a flowchart of an example method 400 to activate a tire pressure measurement system of a vehicle. The flowchart of FIG. 4 is representative of machine readable instructions that are stored in memory (such as the memory 212 of FIG. 2) and include one or more programs which, when executed by a processor (such as the processor 210 of FIG. 2), cause the vehicle 100 to implement the example TPMS controller 124 of FIGS. 1-2. While the example program is described with reference to the flowchart illustrated in FIG. 4, many other methods of implementing the example TPMS controller 124 may alternatively be used. For example, the order of execution of the blocks may be rearranged, changed, eliminated, and/or combined to perform the method 400. Further, because the method 400 is disclosed in connection with the components of FIGS. 1-3, some functions of those components will not be described in detail below.

Initially, at block 402, the TPMS controller 124 determines whether the TPMS of the vehicle 100 is in active mode. In response to the TPMS controller 124 determining that the TPMS is in the active mode, the method 400 proceeds to block 412. Otherwise, in response to the TPMS controller 124 determining that the TPMS is not in the active mode, the method 400 proceeds to block 404.

At block 404, the TPMS controller 124 determines whether the gyroscopes 114 and/or other sensors have detected rotation of the tires 110 of the vehicle 100. In response to the TPMS controller 124 determining that rotation of the tires 110 has been detected, the method 400 proceeds to block 406 at which the TPMS controller 124 activates the TPMS into active mode. Otherwise, in response to the TPMS controller 124 determining that rotation of the tires 110 has not been detected, the method 400 proceeds to block 408.

At block 408, the TPMS controller 124 determines whether the TPMS of the vehicle 100 is in sleep mode. In response to the TPMS controller 124 determining that the TPMS is not in the sleep mode, the method 400 proceeds to block 418. Otherwise, in response to the TPMS controller 124 determining that the TPMS is in the sleep mode, the method 400 proceeds to block 410 at which the TPMS controller 124 collects current tire pressure measurements of the tires 110 via the TPMS sensors 112 at a sleep mode rate (e.g., once every 6 hours). In some examples, the TPMS controller 124 presents the current tire pressure measurements to the user 120 (e.g., via the HMI unit 104, the mobile device 118, etc.) while the TPMS is in the sleep mode.

Returning to block 412, when the TPMS is in the active mode, the TPMS controller 124 collects current tire pressure measurements of the tires 110 via the TPMS sensors 112 at an active mode rate (e.g., once every minute). In some examples, the TPMS controller 124 presents the current tire pressure measurements to the user 120 (e.g., via the HMI unit 104, the mobile device 118, etc.) while the TPMS is in the active mode. At block 414, the TPMS controller 124 determines whether one or more of the collected tire pressure measurements is outside a predetermined tire pressure range. For example the predetermined tire pressure range is defined by a lower tire pressure threshold (e.g., a factory-recommended lower limit) and an upper tire pressure threshold (e.g., a factory-recommended upper limit). In response to the TPMS controller 124 determining that none of the collected tire pressure measurements is outside of the tire pressure range, the method 400 proceeds to block 418. Otherwise, in response to the TPMS controller 124 determining that one or more of the collected tire pressure measurements is outside of the tire pressure range, the method 400 proceeds to block 416 at which the TPMS controller 124 presents a tire pressure alert to the user 120 (e.g., via the HMI unit 104, via the mobile device 118, etc.).

At block 418, the TPMS controller 124 determines whether a tire pressure update request has been received. For example, the TPMS controller 124 receives an update request from (1) the HMI unit 104 of the vehicle 100, (2) the mobile device 118 of the user 120 via the communication module 116 of the vehicle 100, and/or via the remote server 214 via the communication module 122 of the vehicle 100. In response to the TPMS controller 124 determining that an update request has not been received, the method 400 returns to block 402. Otherwise, in response to the TPMS controller 124 determining that an update request has been received, the method 400 proceeds to block 420 at which the TPMS controller 124 presents the most recent previously collected tire pressure measurements to the user 120 (e.g., via the HMI unit 104, the mobile device 118, etc.).

At block 422, upon receiving the update request, the TPMS controller 124 determines whether the TPMS of the vehicle 100 is in the active mode. In response to the TPMS controller 124 determining that the TPMS is in the active mode, the method 400 proceeds to block 426. Otherwise, in response to the TPMS controller 124 determining that the TPMS is not in the active mode, the method 400 proceeds to block 424 at which the TPMS controller 124 sets the TPMS into a real-time mode. At block 426, the TPMS controller 124 collects current tire pressure measurements from the TPMS sensors 112 of the vehicle 100 at a real-time mode rate (e.g., at a variable rate between five minutes and ten minutes). At block 428, the TPMS controller 124 presents the current tire pressure measurements to the user 120 (e.g., via the HMI unit 104, the mobile device 118, etc.).

At block 430, the TPMS controller 124 determines whether one or more of the collected tire pressure measurements is outside of the predetermined tire pressure range. In response to the TPMS controller 124 determining that none of the collected tire pressure measurements is outside of the tire pressure range, the method 400 returns to block 402. Otherwise, in response to the TPMS controller 124 determining that one or more of the collected tire pressure measurements is outside of the tire pressure range, the method 400 proceeds to block 432 at which the TPMS controller 124 presents a tire pressure alert to the user 120 (e.g., via the HMI unit 104, via the mobile device 118, etc.).

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively. Additionally, as used herein, the terms “module,” “unit,” and “node” refer to hardware with circuitry to provide communication, control and/or monitoring capabilities, often in conjunction with sensors. A “module,” a “unit,” and a “node” may also include firmware that executes on the circuitry.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A vehicle comprising:
a communication module; and
a tire pressure measurement system (TPMS) including a TPMS sensor and a controller, the controller to:
determine, responsive to receiving an update request, whether the TPMS sensor is paired with the communication module; and
responsive to determining the TPMS sensor is not paired:
activate the TPMS in a real-time mode;
collect a current measurement from the TPMS sensor upon activation; and
present the current measurement.

2. The vehicle of claim 1, further including a cluster unit, wherein, when a TPMS unit is open in the cluster unit, the controller receives the update request from the cluster unit and presents the current measurement via the cluster unit.

3. The vehicle of claim 1, wherein the controller is configured to activate the TPMS in the real-time mode when a tire corresponding to the tire is stationary.

4. The vehicle of claim 1, wherein the controller receives the update request from a remote server via the communication module, the remote server includes at least one of a taxi dispatcher system and an autonomous vehicle administrator portal.

5. The vehicle of claim 1, wherein the controller receives the update request from a mobile device via the communication module when a TPMS app is open on the mobile device.

6. The vehicle of claim 5, wherein the controller is to send a signal to the mobile device, via the communication module, to instruct the mobile device to present the current measurement.

7. The vehicle of claim 1, wherein the TPMS is configured to:
remain in the real-time mode while a TPMS app remains open; and
return to a previous mode of operation after the TPMS app has been closed for a predetermined period of time.

8. The vehicle of claim 7, wherein the controller instructs the TPMS to decrease a rate at which tire pressure measurements are collected as a time in which the TPMS app remains open increases.

9. The vehicle of claim 1, wherein the controller presents a previous tire pressure measurement responsive to receiving the update request and prior to collecting the current measurement.

10. The vehicle of claim 1, wherein the controller is configured to present a low-pressure alert responsive to determining that the current measurement is less than a first threshold pressure and present a high-pressure alert responsive to determining that the current measurement is greater than a second threshold pressure.

11. The vehicle of claim 1, wherein the communication module receives tire pressure measurements from the TPMS sensor via at least one of a Bluetooth® low-energy protocol, an ultra-high frequency protocol, a Wi-Fi® protocol, and an ultra-wide band protocol.

12. The vehicle of claim 1, wherein, to activate the TPMS and collect the current measurement from the TPMS sensor, the controller is configured to:
send a low-frequency wake-up signal to the TPMS sensor via the communication module;
establish Bluetooth® low-energy communication between the communication module and the TPMS sensor upon the TPMS sensor receiving the low-frequency wake-up signal;
send an instruction to the TPMS sensor via the Bluetooth® low-energy communication to collect the current measurement; and
receive the current measurement from the TPMS sensor via the Bluetooth® low-energy communication.

13. The vehicle of claim 1, wherein the TPMS sensor is not paired with the communication module when the TPMS is in sleep mode, wherein the TPMS enters the sleep mode responsive to a tire being stationary for a predetermined period of time.

14. The vehicle of claim 13, wherein the TPMS enters an active mode drive mode responsive to the tire rotating after being stationary for the predetermined period of time, the TPMS sensor is paired with the communication module when the TPMS is in the active mode.

15. The vehicle of claim 13, further including a gyroscope to detect whether the tire is stationary or rotating.

16. The vehicle of claim 1, wherein the TPMS sensor collects and transmits a tire pressure measurement at a high rate in an active mode, at a low rate in a sleep mode, and at a medium rate in the real-time mode.

17. A method comprising:
receiving an update request for a tire pressure measurement system (TPMS) sensor of a vehicle;
determining, upon receiving the update request, whether the TPMS is paired with a communication module of the vehicle; and
responsive to determining that the TPMS sensor is not paired:
activating a TPMS in a real-time mode;
collecting a current measurement from the TPMS sensor upon activation; and
presenting the current measurement via an HMI unit.

18. The method of claim 17, wherein the update request is received from at least one of the a cluster unit and a remote server via the communication module.

19. The method of claim 17, wherein the update request is received from a mobile device via the communication module when a TPMS app is open on the mobile device.

20. The method of claim 17, further including presenting a previous tire pressure measurement responsive to receiving the update request and prior to collecting the current measurement.
